(19) United States
(12) Patent Application Publication
(10) Pub. No.: US 2014/0217220 A1
(43) Pub. Date: Aug. 7, 2014

(54) Cutter Arrangement Pattern for Maintaining Rotor Balance

(71) Applicant: Vermeer Manufacturing Company, Pella, IA (US)

(72) Inventor: Clint Weinberg, Pella, IA (US)

(21) Appl. No.: 13/920,796

(22) Filed: Jun. 18, 2013

Related U.S. Application Data
(60) Provisional application No. 61/762,107, filed on Feb. 7, 2013.

(51) Int. Cl. B02C 18/18

(52) U.S. Cl. CPC B02C 18/18
USPC 241/282.1; 29/428

(57) ABSTRACT

A method and apparatus for providing for a balanced rotor having cutting teeth attached thereto. The longitudinal length of the rotor is conceptually divided in half by a plane disposed perpendicular to the axis of rotation. The cutting teeth are arranged in a plurality of helices about the rotor so each half of the rotor is statically balanced. The cutting teeth are further arranged so the centers of mass of the two halves are equidistant from the dividing plane. A gap may exist between the ends of the rotor and the nearest tooth encountered in each helix. The gaps for different helices may be different, however, the gaps at each end of each helix are the same length. The above result in a rigidly balanced rotor.

### TECHNICAL FIELD

This invention relates generally to a cutter arrangement pattern for maintaining adequate rotor balance and more particularly to such an arrangement which maintains such adequate rotor balance to prevent vibration of the rotor despite wear on cutter teeth or replacement of original cutter teeth with another size or type cutter teeth.

### BACKGROUND

As those of ordinary skill are aware, a rotating body is considered balanced when it satisfies the requirements for both static and dynamic balancing. Static balance implies that the sum of the inertial forces caused by the rotation sum to zero:

$${\sum }_{n = 1}^{{N}_{t}} {m}_{n} {R}_{n} {ω}^{2} = 0 \qquad ( 1 )$$

Dynamic balance takes into account the length of the rotor. Besides requiring static balance, dynamic balance also implies the total moment about the rotor's axis of rotation due to inertial forces normal to it is zero:

$${\sum }_{n = 1}^{{N}_{t}} {m}_{n} {R}_{n} {ω}^{2} {x}_{n} = 0 \qquad ( 2 )$$

The center of mass of a body may be found as:

$$\overline{x} = \frac{{\sum }_{n = 1}^{{N}_{t}} {x}_{n} m}{{\sum }_{n = 1}^{{N}_{t}} m} = \frac{{\sum }_{n = 1}^{{N}_{t}} Rm cos {θ}_{n}}{{\sum }_{n = 1}^{{N}_{t}} m} , \\ \overline{y} = \frac{{\sum }_{n = 1}^{{N}_{t}} {y}_{n} m}{{\sum }_{n = 1}^{{N}_{t}} m} = \frac{{\sum }_{n = 1}^{{N}_{t}} Rm sin {θ}_{n}}{{\sum }_{n = 1}^{{N}_{t}} m} , \\ and , \\ \overline{z} = \frac{{\sum }_{n = 1}^{{N}_{t}} {z}_{n} m}{{\sum }_{n = 1}^{{N}_{t}} m} \qquad ( 3 )$$

where x̅, y̅, and z̅ are the coordinates of the center of mass. The coordinate system used herein may be seen in FIG. 9a and FIG. 9b.

The above equations may be found in many undergraduate textbooks such as Design of Machinery an Introduction to the Synthesis and Analysis of Mechanisms and Machines 5^{th} ed. by Robert L. Norton, published by McGraw Hill; ISBN #978-0-07-352935-4, hereby incorporated in its entirety by reference.

In the case of a rotor having a finite number of cutters having equal masses, m, attached at a common radius, R, and all rotating at the same angular speed, ω, Equation (1) may be reduced to the two components:

$${\sum }_{n = 1}^{{N}_{t}} cos {θ}_{n} = 0 \\ and \\ {\sum }_{n = 1}^{{N}_{t}} sin {θ}_{n} = 0 \qquad ( 4 )$$

Where, for static balance, both of these Equations 4 must hold true.

Under the same assumptions, Equations 3 reduce to the dimensionless relations:

$$\begin{matrix}\frac{\overline{x}}{R} = \frac{1}{{N}_{t}} {\sum }_{n = 1}^{{N}_{t}} {x}_{n} = \frac{1}{{N}_{t}} {\sum }_{n = 1}^{{N}_{t}} cos {θ}_{n} & ( 5 a ) \\ \frac{\overline{y}}{R} = \frac{1}{{N}_{t}} {\sum }_{n = 1}^{{N}_{t}} {y}_{n} = \frac{1}{{N}_{t}} {\sum }_{n = 1}^{{N}_{t}} sin {θ}_{n} & ( 5 b ) \\ \frac{\overline{z}}{𝓁} = \frac{1}{{N}_{t}} {\sum }_{n = 1}^{{N}_{t}} \frac{{z}_{n}}{𝓁} & ( 5 c )\end{matrix}$$

Comparing Equations 4 with Equations 5a and 5b, it is evident, if a rotor is statically balanced, its center of mass will lie on its axis of rotation ( x̅= y̅=0).

Two of many prior art methods to maintain a balanced rotor are to start the cutter tip pattern from opposite ends, using four equally angularly-spaced rows. Balance weights are added to produce a balanced rotor based on the particular tooth mass used. In these and other patterns, as the teeth wear, the rotor becomes imbalanced. This imbalance effect is due to balancing for a specific weight distribution that is only held within tolerances when there has been very little wear on the cutter tips, often requiring the cutter tips to be replaced with new ones for balance purposes before the cutter tips are actually worn out.

Accordingly there is a need for a simple and reliable way to arrange cutter tips to minimize rotor imbalance problems that might be otherwise caused by changing the cutter tips to a different size or type or due to wear on the cutter tips over time and so that a single rotor can be used in various applications.

### SUMMARY OF THE INVENTION

A purpose of this invention is to create a pattern that arranges the cutting structures, cutter tips, or cutting teeth in a way that the mass of the tip has no effect on the balance of the rotor. Rotors with such cutting structures attached are used in such operations, including but not limited to, chipping, grinding, crushing, surface planing and mulching, as seen in FIGS. 1-3. It is to be noted that “cutting”, for the purposes of this application, may include any of a shearing, grinding, crushing, or other size-reducing action. Since the desired product can vary greatly in these operations, the style of teeth can vary significantly in mass and center of mass. Also, as teeth wear, assuming wear is fairly even across the working area, the balance is not affected due to the nature of this pattern.

One embodiment of this invention in its simplest form allows for two helical patterns of cutting teeth. Each helix begins and ends at the same angular location on the rotor—that is, the first and last tooth in each helix occupy the same angular position on the rotor. The two helices are angularly displaced from one another by 180°. A gap between the nearest end of the rotor and the first tooth may be different between the two helices. A gap between the nearest end of the rotor and the last tooth may be different between the two helices. The proposed cutter structure pattern allows for a single rotor to be used in various applications using different cutter tip types or sizes—the entire set of cutter tips being used at a given time, however, are essentially the same type and size (i.e., within expected engineering tolerances).

The present invention is not limited to two helices per rotor.

The present invention considers a rotor conceptually divided into two equal length rotors by a plane that is perpendicular to the rotor's axis of rotation. Each of the halves must satisfy or closely approach the requirements for static balance as given in Equation 1. Additionally, the centers of mass of the halves preferably lie substantially the same distance from the plane dividing the rotor in two. These two requirements result in an adequately balanced rotor.

For the purposes of this document, including the claims, the term rigidly balanced applied to a rotating structure is hereby defined as the case when the rotating structure is divided in half longitudinally, each half being substantially statically balanced and the centers of gravity for the two halves are located at substantially equal distances from the longitudinal center of the rotating structure. Those of ordinary skill in the art are able to assess permitted unbalance as explained below.

Therefore, the present invention is for a rigidly balanced rotor.

Permissible imbalance in rotors is well known to those of ordinary skill in the art. Nomograms, such as those shown in the paper, “Balance Quality Requirements of Rigid Rotors,” published as IRD Balancing Technical Paper 1 by IRD Balancing of Louisville, Ky. U.S.A., which paper is hereby incorporated in its entirety by reference, are used to determine permissible imbalance. Such balance tolerance nomograms are industry standards in accordance with ISO 1940 and ANSI S2.19-1975.

Therefore, a rigidly balanced rotor shall be adequately statically balanced, and the centers of gravity for the two halves shall be located sufficiently near equal distances from the longitudinal center of the rotor meet an appropriate G-grade as determined by those of ordinary skill in the art. As uncertainties and tolerances always exist in rotor balancing, the present invention is not limited to exact static balance and exact equal distances of the centers of gravity for the two halves from its longitudinal center.

Another purpose of this pattern is to create a cutter tip arrangement with a helical twist that allows for predictable tooth placement while still maintaining optimal balance features.

Other objects, advantages, and novel features of the invention will become apparent from the following detailed description of the invention when considered in conjunction with the accompanying drawings.

### BRIEF DESCRIPTION OF THE DRAWINGS

FIG. 1 is a perspective view of a horizontal grinding machine that has a rotor that could be of the type of the present invention;

FIG. 2 is a perspective view of a tub or vertical grinding machine that has a rotor that could be of the type of the present invention;

FIG. 3 is a perspective view of a forestry tractor or also known in the industry as a forestry mulcher, forestry mower, or terrain leveler machine that has a rotor that could be of the type of the present invention;

FIG. 4a is a perspective view of a rotor constructed in accordance with the present invention that could be used on a grinder like the ones shown in FIGS. 1 and 2, for example;

FIG. 4b is a perspective view of a rotor constructed in accordance with the present invention that could be used on a forestry tractor, like the one shown in FIG. 3, for example;

FIG. 4c is a side elevation view of a rotor constructed in accordance with the present invention.

FIG. 5 is a schematic view of a rotor showing the points of placement of cutter tips for a first preferred embodiment of the present invention, for example for the rotor of FIG. 4b;

FIG. 6 is a schematic view of a rotor showing the points of placement of cutter tips for a second preferred embodiment of the present invention wherein the direction of rotation of the helices reverses at a center of the rotor;

FIG. 7 is a schematic view of a rotor showing the points of placement of cutter tips for a third preferred embodiment of the present invention wherein the helices make a plurality of rotations about the rotor;

FIG. 8 is a schematic view of a rotor showing the points of placement of cutter tips for a fourth preferred embodiment of the present invention wherein more than two helical patterns are used on a single rotor;

FIG. 9a is a perspective view of a rotor, the rotor's longitudinal length conceptually divided in half by a plane disposed orthogonal to the rotor's axis of rotation, and a coordinate system used herein; and

FIG. 9b is a perspective view of a rotor with centers of mass shown schematically for each of the two halves formed by conceptually dividing the rotor in half with a plane disposed orthogonal to the rotor's axis of rotation.

### DETAILED DESCRIPTION OF THE INVENTION

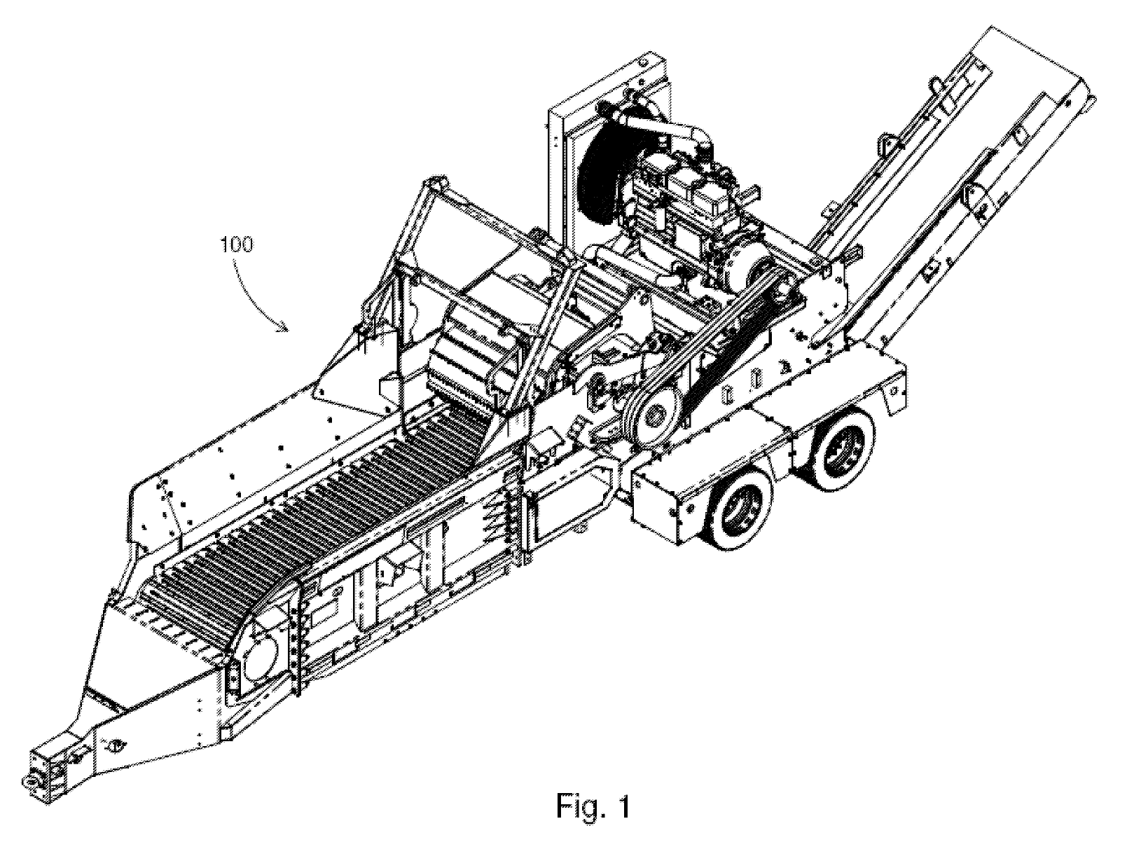

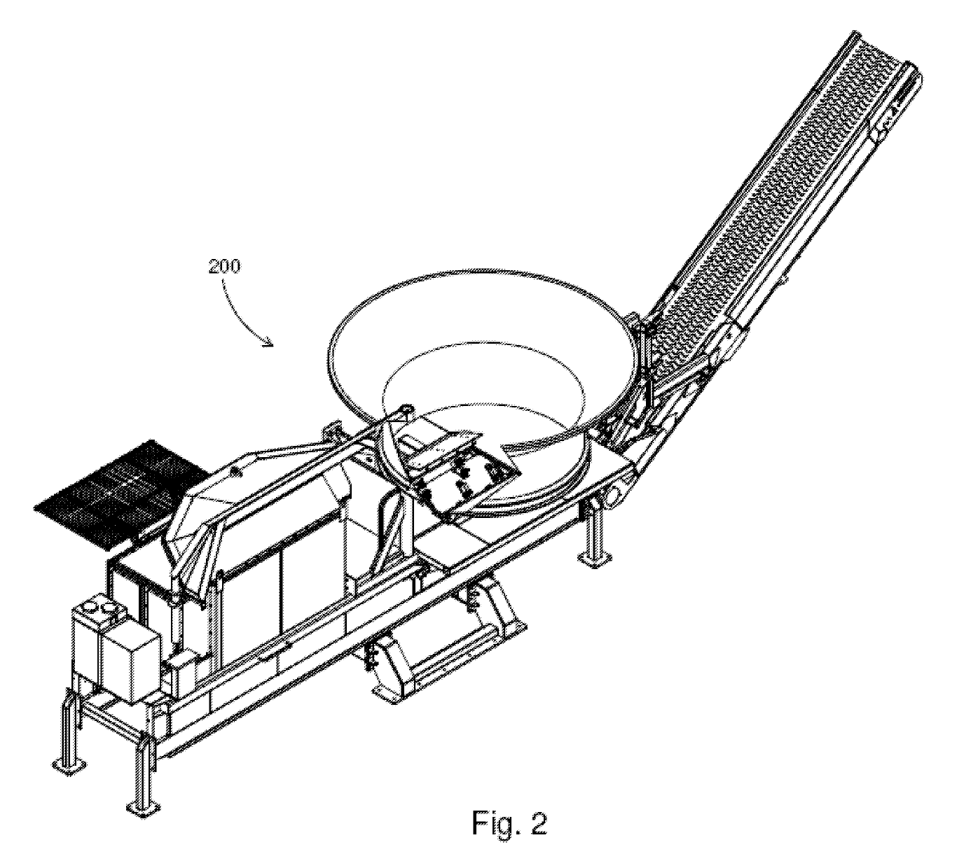

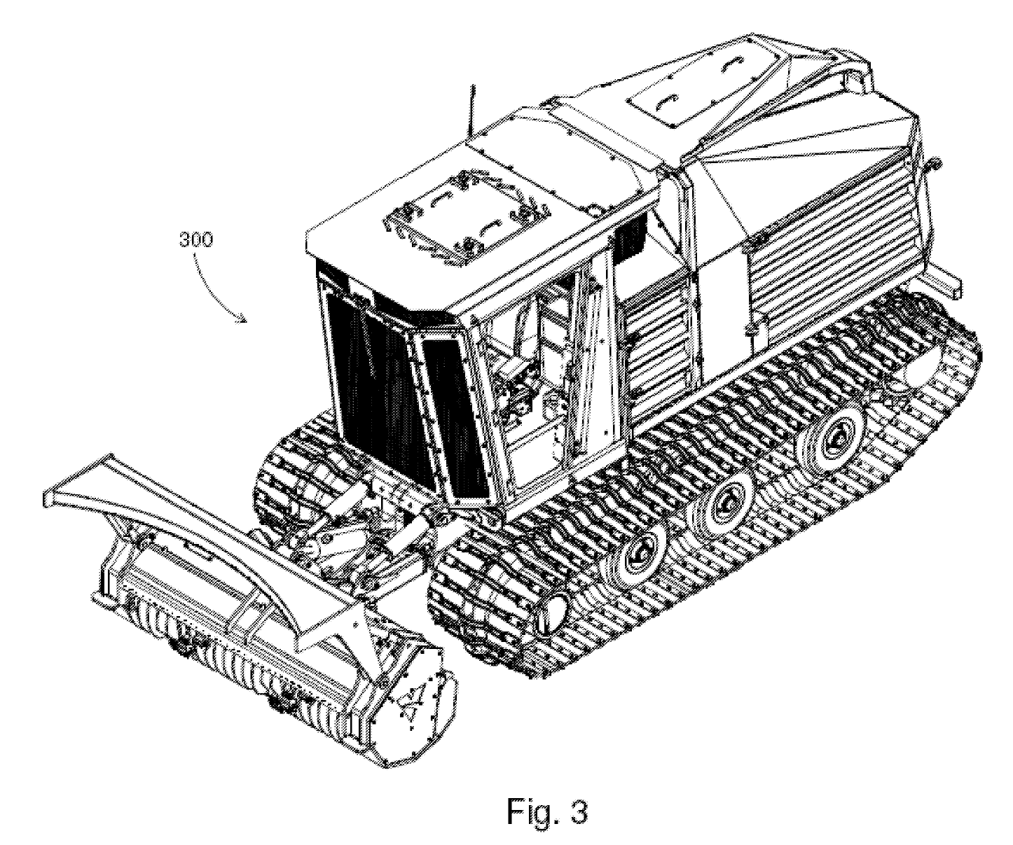

There is a plurality of uses for rotors having cutting structures attached thereto. FIGS. 1-3 illustrate some of the machines incorporating rotors having cutting teeth. FIG. 1 shows a horizontal grinding or chipping machine 100 that may be used for chipping or grinding trees and brush. FIG. 2 shows a tub grinding machine 200 for purposes similar to the machine 100 of FIG. 1. FIG. 3 shows a forestry tractor, also known in the industry as a forestry mulcher, forestry mower, or terrain leveling machine 300 used to break up and level the ground and material covering the ground, such as mulch.

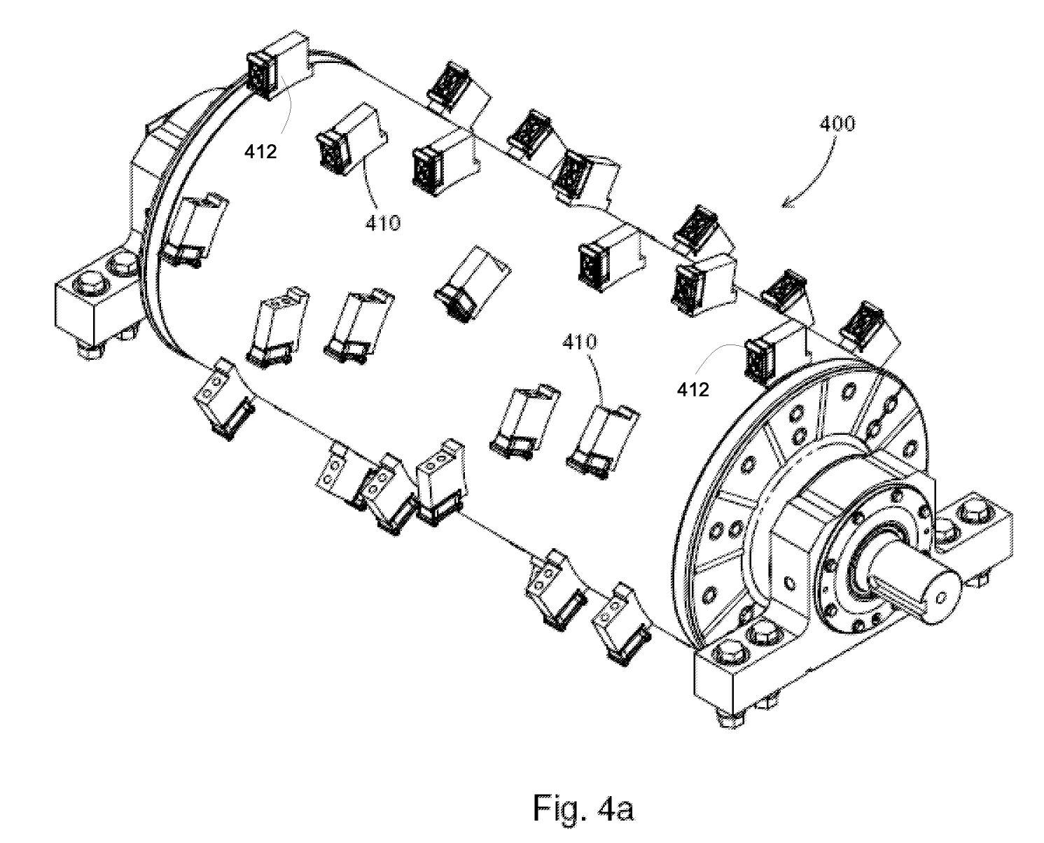

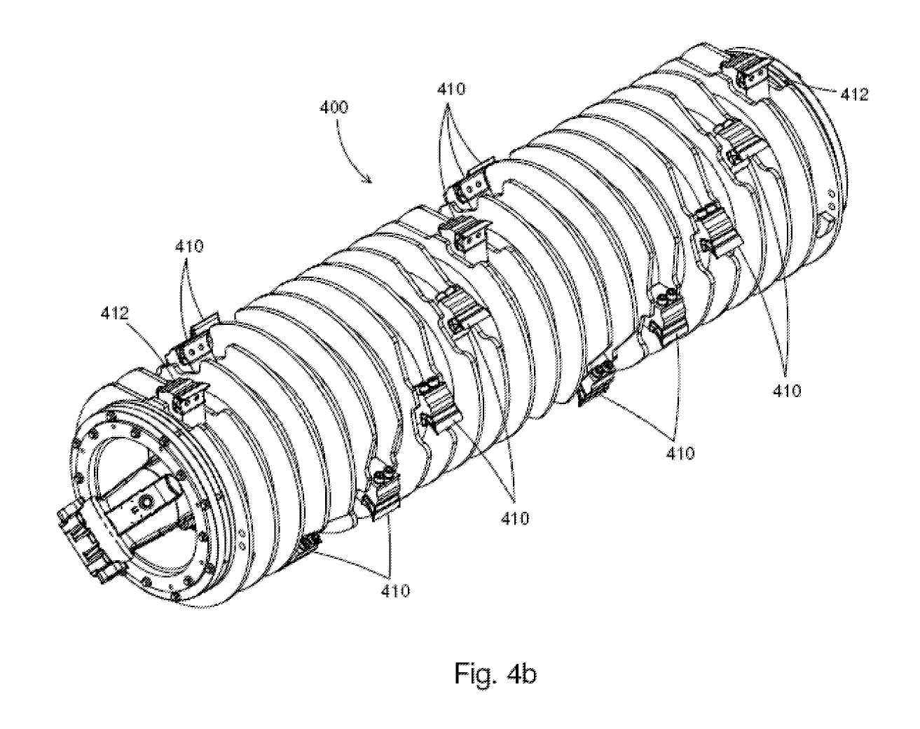

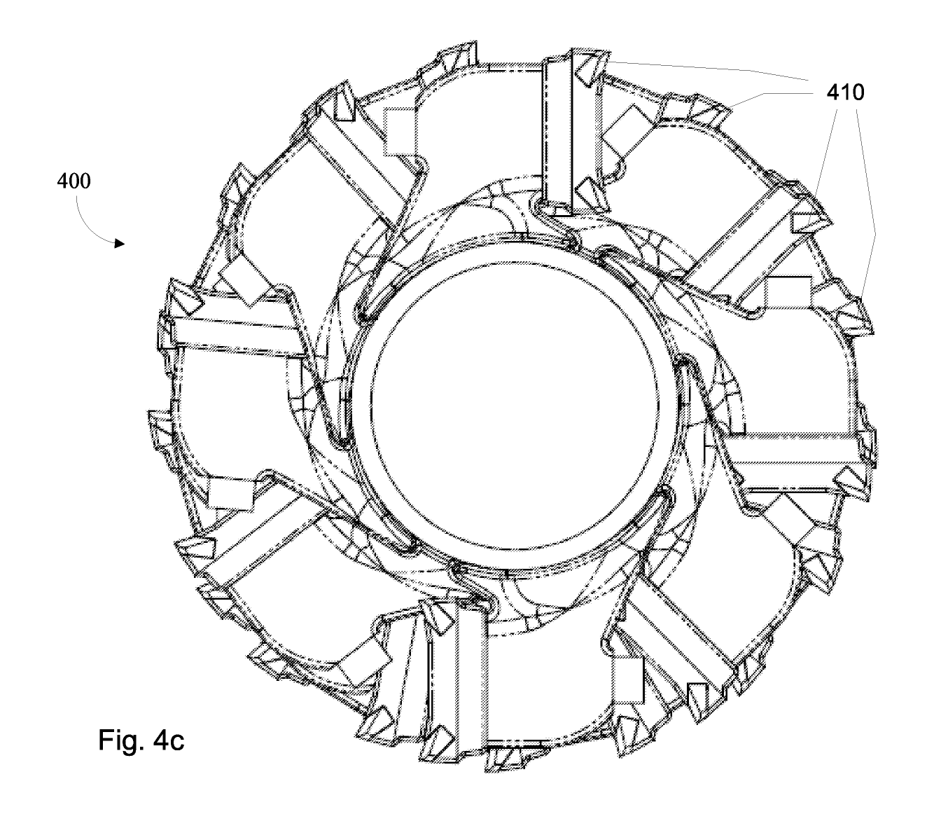

A rotor 400 having a plurality of teeth 410, 412 affixed thereto is shown in FIG. 4a, the rotor being truncated at the near (right) end. The teeth 410, 412 are arranged in two helical patterns spaced 180° apart and complete three revolutions across the length of the rotor. Another complete rotor 400 is illustrated in FIG. 4b. The end teeth 412, that is, those nearest the ends of the rotor 400 occupy the same angular location on the rotor 400. The teeth 410, 412, on the rotor 400 in FIG. 4b, complete one revolution across the length of the rotor 400. The side elevational view in FIG. 4c of the rotor 400 illustrates the angular distribution of the teeth 410, 412. Despite the random appearance of this distribution from this view, the teeth 410, 412 are set in helices as shown in FIGS. 4a and 4b.

As suggested by the examples set forth in FIGS. 4a and 4b, the teeth 410, 412 should be aligned in a manner so as to complete a number (e.g., 1, 2, 3, etc.) of revolutions along the length of the rotor 400, with the caveat that the two teeth 412 in each helix nearest the two ends of the rotor 400 occupy the same angular location on the rotor 400.

The cutter teeth 410, 412 and the way they are mounted to the rotor 400 may be effected as any of the rotors and cutter tips shown in U.S. Pat. No. 4,773,600 to Stumpit; U.S. Pat. No. 5,971,305 to Davenport; U.S. Pat. No. 6,880,774 to Bardos et al.; U.S. Pat. No. 7,222,808 to Edwards; U.S. Pat. No. 7,959,099 to Cox et al.; U.S. Pat. No. 7,967,044 to Labbe et al.; U.S. Published Patent Application 2011/0100658 to Stanley et al. or Patent document WO2007034038-PCT/F12006/050399 to Kinnunen, all of which are incorporated herein by reference in their entirety.

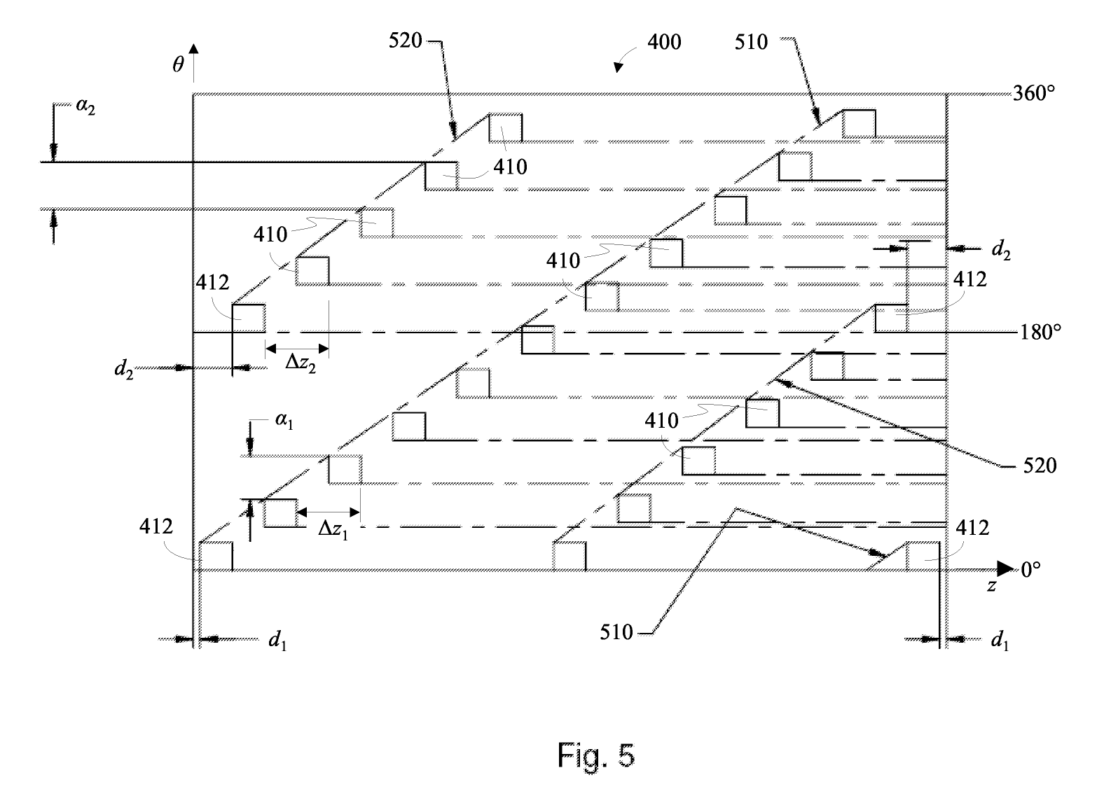

The schematic of a rotor 400 of FIG. 5 shows the rotor 400 unrolled such that the vertical direction represents angular variation, while the axial length is represented in the horizontal direction. The overall axial length of this rotor is l. In this view, helices are shown as linear, diagonal patterns. Not all the teeth 410 were given reference numbers. Again, two helices 510, 520 are illustrated. The first helix 510 comprises the teeth 410, 412 in the longest diagonal beginning at the lower left, which is the left side of the rotor 400 and essentially at a zero degree angle. The teeth 410, 412 of the first helix 510 continue from the lower left toward the upper right of the figure. However, the final tooth 412 of the first helix 510 resides in the lower right hand corner of the figure at the right-hand end of the rotor 400 and essentially at a zero-degree angular position. Hence, the first and last tooth 412 of the first helix 510 reside in effectively the same angular position, but near opposite ends of the rotor 400. The exact level of tolerances on the required for the build/layout will depend on such factors as the size, weight, operating speed, and radius of the rotor, as needed to meet a given balance quality grade G-40, G-16, G-6.3, etc., as determined by one of ordinary skill in the art. Such balance tolerance nomograms are industry standards, in accordance with ISO 1940 and ANSI S2.19-1975.

The second helix 520 begins at the left side of the rotor 400, but essentially at a 180° angular position. The second helix 520 also extends up and to the right until it nears 360° in angular position. It then wraps around the rotor 400 to continue from an effectively zero-degree angular position and then up and to the right, again. As with the first helix 510, the first and last teeth, 412 of the second helix 520 reside in effectively the same angular position (180° in FIG. 5), but near opposite ends of the rotor 400.

The first helix 510 begins and ends at the same distance, d₁, from the ends of the rotor 400, as shown. The second helix 520 begins and ends at the same distance, d₂, from the ends of the rotor 400. In general, d₁≠d₂, hence the lengths of the two helices 510, 520 are different. Since the number of revolutions the two helices 510, 520 take around the rotor 400 is the same, the pitches of the two helices 510, 520 are different.

The number of teeth 410, 412 in the two helices 510, 520 may be different. As a consequence of this and of the patterns described above, the axial spacings, Δz₁ and Δz₂ may be unequal. Additionally, the angular spacings, α₁ and α₂ may also be unequal.

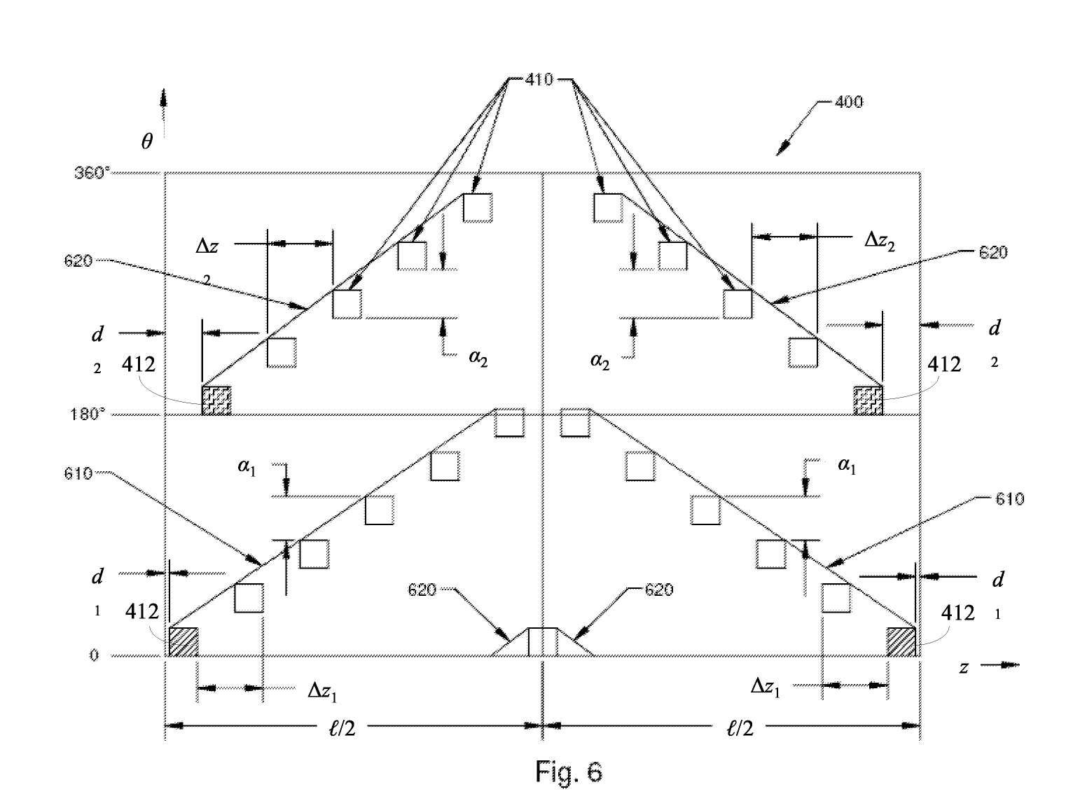

An additional embodiment of the present invention is illustrated in FIG. 6. Here, both helices 610, 620 reverse rotational direction at midspan, l/2, of the rotor 400. This embodiment has the advantage of equalizing the axial force resulting from engaging a homogenous substance while having the helices rotate continually in the same angular direction.

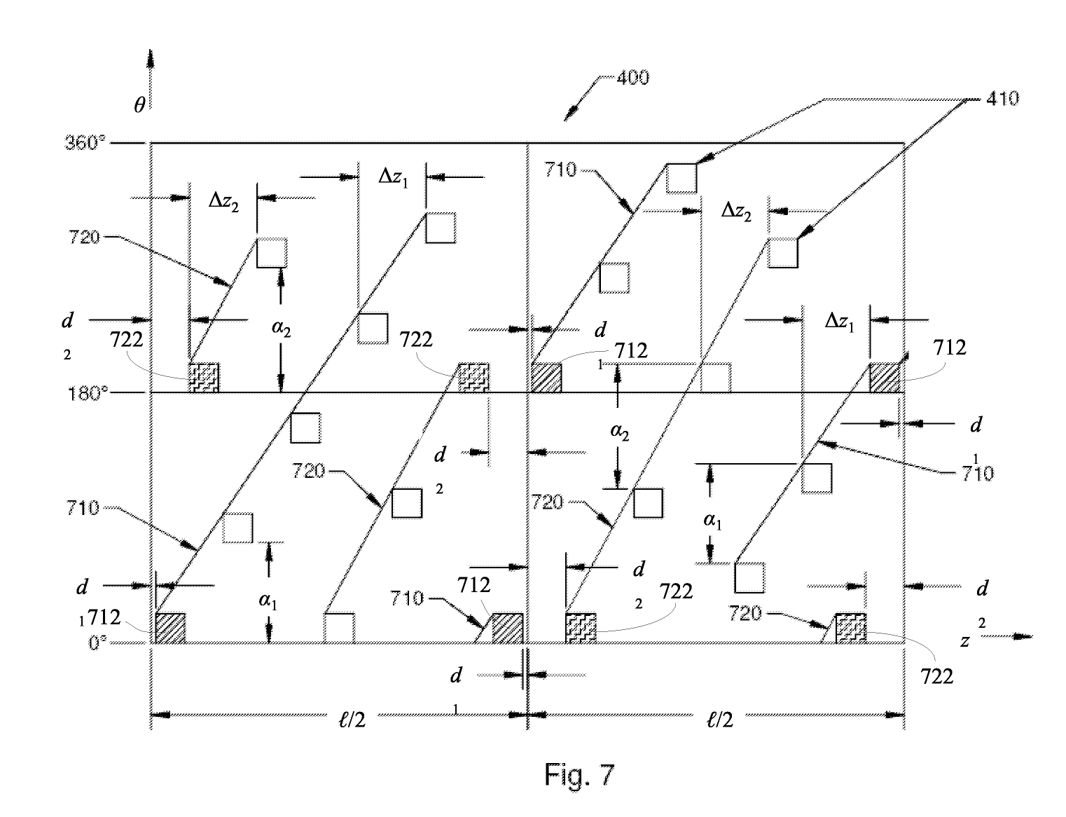

The embodiments in FIG. 6 and FIG. 7 result in a substantially balanced rotor. This balance is classified by meeting a balance tolerance nomogram such as G-2.5, G-6.3, G-16, or even G-40, such as are known in the art. For the purposes of the present disclosure, the levels of balance are generally indicated using the following guidelines: “adequately balanced” as meeting the G-40 grade, “substantially balanced” as meeting the G-16 grade, and “essentially balanced” as meeting the G-6.3 or G-2.5 grade. Further, it is generally understood that such nomograms provide a range or curve, so as long as the rotor balances within the range or at or below the curve for that grade, the rotor would be considered to meet that given level of balance.

In FIG. 7, a rotor 400 is illustrated having a first helix 710, and a second helix 720, each completing two rotations about the rotor 400 with the end teeth 712 in the first helix 710 of each half of the rotor 400 occupying essentially the same angular location, and the end teeth 722 in the second helix 720 of each half of the rotor 400 occupying essentially the same angular location. FIG. 7 illustrates two helix patterns completing one rotation on the left half and two separate helix completing one rotation on the right half. The present invention is not limited to a continuous helix pattern from one end to the other, and nor is the present invention limited to any number of periods the helices 710, 720 complete about the rotor 400, as long as the helices complete a number of rotations with the same caveat as above, that is, the end teeth 712, 722 in each helix reside in essentially the same angular location.

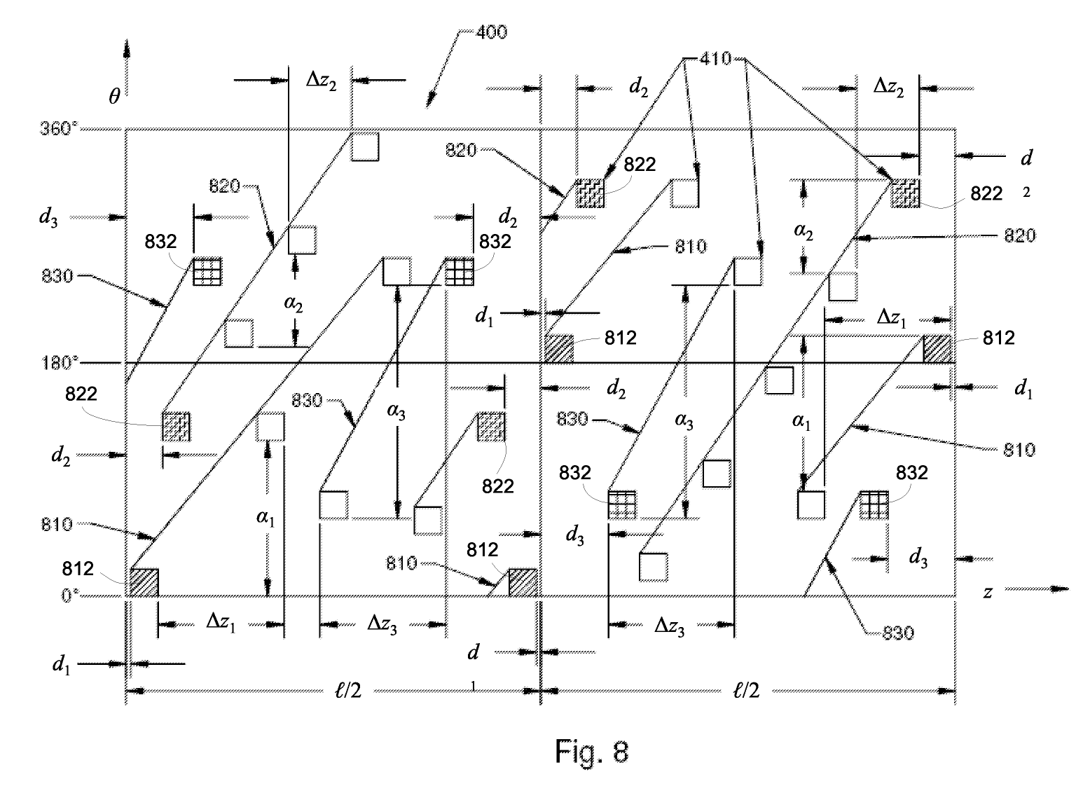

Three complete helices 810, 820, 830 are shown on the same rotor 400 in FIG. 8. The offsets, d₁, d₂, and d₃ from which the end teeth, 812, 822, 832 in each helix 810, 820, 830 lie from the ends of the rotor may all be different in this embodiment. Hence, there may be three unequal pitches, angular spacings, α₁, α₂, and α₃, and axial spacings, Δz₁, Δz₂, and Δz₃. The present invention is not limited to any number of helices 810, 820, 830 used on a single rotor 400.

The two embodiments in FIG. 7 and FIG. 8 result in an even more substantially balanced rotor (i.e., meeting the G-16 grade or better) than generally possible with the other embodiments. In FIG. 7 and FIG. 8 the two halves of the rotor, left and right, can be positioned to any angular position in relation to each other. Even though FIG. 7 and FIG. 8 show an angular position varying by 180°, this invention is not limited to the specific angular position relating the two halves.

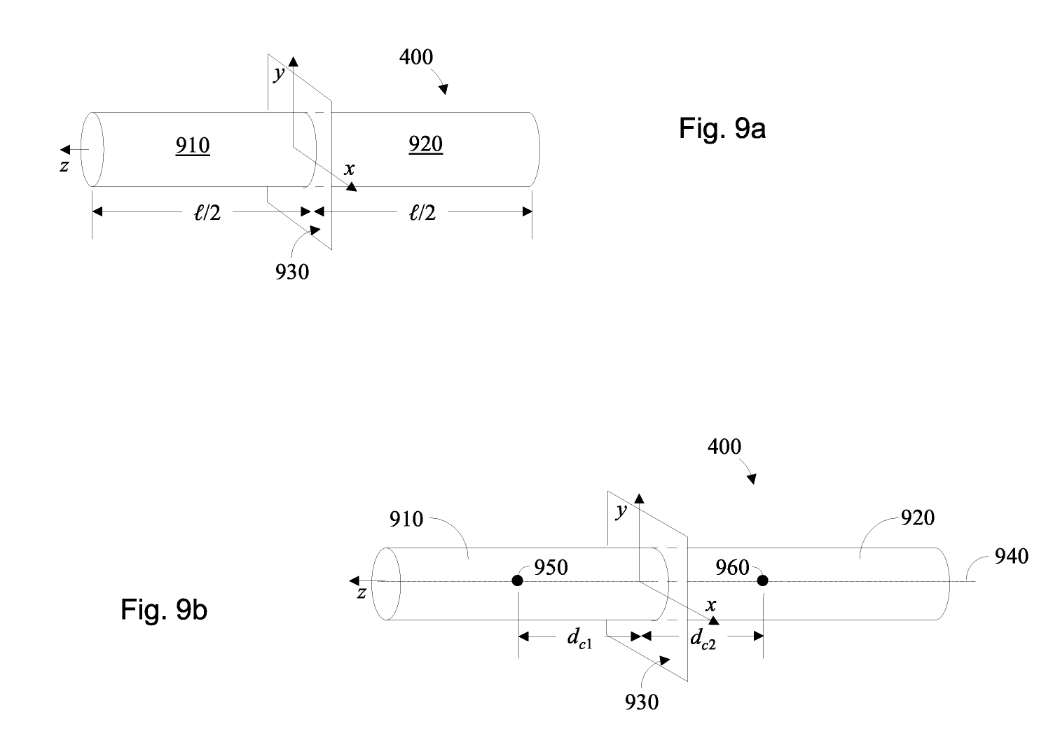

In FIG. 9a, the rotor 400 has been conceptually divided into two halves 910, 920 of equal axial length, l/2 by a plane 930 disposed perpendicular to the axis of rotation 940 (shown in FIG. 9b) of the rotor 400. One of the aspects of the present invention is that each of these two halves 910, 920 can be substantially statically balanced, separately from the other.

The rotor 400 shown in FIG. 9b illustrates another aspect of the present invention. The centers of mass 950, 960 of the two halves 910, 920 of the rotor 400, calculated using the last of Equations 3 or, in dimensionless form, Equation 5c, are preferably substantially equidistant from the plane 930 dividing the rotor 400 in half, hence d_{c1}≈d_{c2}. Those of ordinary skill in the art, using the appropriate nomogram previously mentioned, may specify tolerances to the static balance and the equality of d_{c1} and d_{c2}. It has already been shown that, if the two halves 910, 920 are statically balanced, their centers of mass 950, 960 will reside on the axis of rotation 940. The combination of these two aspects: each half 910, 920 being substantially statically balanced, and their centers of mass being nearly equidistant from the plane 930 results in a rigidly balanced rotor. It is, however, noted that the center of mass/gravity of the two halves do not necessarily need to be equidistant, as long as they are both located on the axis of rotation. Due to manufacturing tolerances, this level of alignment may be difficult to achieve. As such, counterweights and/or a balancing program can used to bring the balance within an allowable range, e.g. G-40, G-16, G-6.3, and G-2.5. It is further to be appreciated that the use of counterweights and/or a balancing program can be used in conjunction with any of the other examples and/or design factors provided, in order to help ultimately achieve a desired range of balance.

Obviously many modifications and variations of the present invention are possible in light of the above teachings. It is therefore to be understood that, within the scope of the appended claims, the invention may be practiced otherwise than as specifically described.

1. A drum assembly comprising:
(a) a generally right-circular cylindrically shaped drum having an axial length extending from a first end to a second end;
(b) a plurality of cutting structures operatively attached to the drum;
(c) a plurality of cutting structure patterns, each of said plurality of patterns comprising a helical pattern;
(d) a plurality of pitches associated with the plurality of patterns;
(e) a plurality of first end cutting structures disposed adjacent to the first end of the drum wherein the first end cutting structures are evenly angularly distributed about a circumference of the drum;
(f) a plurality of second end cutting structures disposed adjacent to the second end of the drum wherein each of the second end cutting structures is located at a same angular location as the first end cutting structure in a corresponding helical pattern; and
(g) wherein a combination of said plurality of cutting structure patterns results in a rigidly balanced rotor.

2. The drum assembly of claim 1 additionally comprising a distance, d, from which the first end cutting structure of a specific helical pattern is disposed from the first end of the drum and from which the second end cutting structure of the specific helical pattern is disposed from the second end of the drum.

3. The drum assembly of claim 2 wherein the distance, d, may be zero.

4. The drum assembly of claim 2 wherein the distance, d, may be different for each of the plurality of helical patterns.

5. A method of constructing a rigidly balanced rotor assembly, the rigidly balanced rotor comprising a substantially right-circular cylindrical drum and a plurality of cutting structures operatively disposed on the drum, the method comprising:
(a) conceptually, longitudinally, dividing the drum into a first half and a second half;
(b) arranging the cutting structures disposed on the first half of the drum such that a corresponding first half of the rotor assembly is substantially statically balanced and such that a first center of gravity of the first half of the rotor assembly is disposed a distance, d_{c1}, from the center of the rotor assembly; and
(c) arranging the cutting structures disposed on the second half of the drum such that a corresponding second half of the rotor assembly is substantially statically balanced and such that a second center of gravity of the second half of the rotor is disposed the distance, d_{c2}, from the center of the rotor assembly, the distance, d_{c2}, being substantially equal to the distance, d_{c1}.

6. The method of claim 5 wherein arranging the cutting structures disposed on the first half of the drum comprises arranging the cutting structures in a helical pattern.

7. The method of claim 5 wherein arranging the cutting structures disposed on the second half of the drum comprises arranging the cutting structures in a helical pattern.

8. The method of claim 5 wherein arranging the cutting structures disposed on the first half of the drum comprises arranging the cutting structures in a helical pattern having a first rotation direction and wherein arranging the cutting structures disposed on the second half of the drum comprises arranging the cutting structures in a helical pattern having a second rotation direction.

9. The method of claim 8 wherein the first rotation direction is opposite the second rotation direction.

10. The method of claim 5 wherein the second half of the drum, with the cutting structures affixed thereto, may be rotated to any angular position relative to the first half of the drum.

11. The drum assembly of claim 1 wherein a level of balance associated therewith meets the G-40 standard, in accordance with ISO 1940 and ANSI S2.19-1975.

12. The drum assembly of claim 11 wherein a level of balance associated therewith meets the G-16 standard, in accordance with ISO 1940 and ANSI S2.19-1975.

13. The method of claim 5 additionally comprising adding at least one balance mass to achieve adequate static balance in accordance with ISO 1940 and ANSI S2.19-1975.

14. The method of claim 5 additionally comprising adding at least one balance mass to achieve adequate equality to the locations of the first and second centers of gravity in accordance with ISO 1940 and ANSI S2.19-1975.
